(19) United States
(12) Patent Application Publication
(10) Pub. No.: US 2021/0111499 A1
(43) Pub. Date: Apr. 15, 2021

(54) LENS REPEATER WITH VARIABLE BEAMWIDTH

(71) Applicant: Amphenol Antenna Solutions, Inc., Rockford, IL (US)

(72) Inventor: Jimmy HO, Hickory, NC (US)

(21) Appl. No.: 17/067,051

(22) Filed: Oct. 9, 2020

Related U.S. Application Data
(60) Provisional application No. 62/914,063, filed on Oct. 11, 2019.

(51) Int. Cl. H01Q 25/00; H01Q 19/06; H01Q 3/46

(52) U.S. Cl. CPC H01Q 25/002; H01Q 3/46; H01Q 19/06

(57) ABSTRACT

A lens apparatus has a spherical dielectric lens, a feed unit transmitting and/or receiving signals through the spherical lens, and an adjustable positioning system that adjustably positions the feed unit at a desired radial distance from the spherical dielectric lens.

### CROSS-REFERENCE TO RELATED APPLICATIONS

This application claims the benefit of priority of U.S. Patent Application Ser. No. 62/914,063 filed on Oct. 11, 2019 and entitled “Highly Efficient Variable Beamwidth Lens Repeater,” the content of which is relied upon and incorporated herein by reference in its entirety.

### FIELD OF THE DISCLOSURE

The present disclosure relates to a wireless communication device and in particular, a low visual impact highly efficient millimeter lens antenna repeater that can be mounted on a street corner, carried around by a consumer to direct and refocus signals for a personal wireless hotspot or mounted on a lamppost for high data rate communications in microwave-based networks, for example 5th-generation (“5G”) mm-wave networks. These repeaters are able to deliver high data rate communications to areas not served by the Line-of-Site (LoS) coverage of a mm-wave base station by receiving and then redirecting signals to and from the base station with high gain, low loss by means of a dielectric lens. The present disclosure enables additional functionality for an active or passive repeater employing a lens antenna.

### BACKGROUND

It is well known that the coverage area of a mobile radio base station may be extended by means of arrangements known as repeaters. These are commonly employed to add coverage in areas in which transmission between a base station and a user equipment such as a mobile phone or computing device, is blocked by buildings, trees or other obstacles. A repeater according to prior art is typically provided with a first antenna referred to as a donor antenna that transmits signals to and from a base station, and a second antenna referred to as a service antenna that communicates with users in the extended area of coverage. Both the donor antenna and the service antenna transmit and receive radio signals. An arrangement in which the donor and service antennas are directly connected by radio frequency transmission lines is known as a passive repeater. Arrangements in which the donor and service antennas are connected through radio frequency circuit arrangements such as amplifiers are known as active repeaters. At frequencies greater than 6 GHz, now being developed for mobile radio use, the propagation characteristics of radio waves becomes similar to those of light, so propagation within city areas becomes problematic; a signal directed along a city street will not propagate into side streets, even one close to the base station, so the use of repeaters becomes an essential tool for the provision of adequate coverage,

The Applicant's previous application U.S. Ser. No. 16/822,778, the entire contents of which is hereby incorporated by reference. discloses (among other things) both active and passive repeater arrangements based on the use of at least one substantially spherical lens formed from at least one low loss dielectric material and provided with feed arrangements to support a bi-directional donor beam linking the repeater to a base is station and a service beam linking the repeater to users' equipment. This prior application further describes arrangements whereby a single lens may be provided with additional feed arrangements to support configurations comprising multiple service beams and/or multiple user beams.

FIG. 1 shows the principle of operation of a prior art passive relay arrangement comprising a dielectric lens 1 provided with feed units 2, 3 connected by a radio frequency guided transmission medium such as a coaxial cable or waveguide 4. Lens antenna 1 focuses incoming radio signals from a base station onto donor feed unit 2. Donor feed unit 2 and service feed unit 3 are operatively connected by means of radio frequency transmission media such as waveguides or coaxial cables 4, Outgoing radio frequency signals from service feed unit 3 form a radiated service beam 7 having a typical form 8. Outgoing radio frequency signals from donor feed unit 2 form a radiated donor beam 5 having a typical form 6. In a practical case the transmissions supported by both the donor and service beams are usually bidirectional: signals received from the donor base station are retransmitted by the service beam to users within it; conversely signals received from users within the service beam are re-transmitted by the donor beam to the donor base station.

The radio frequency transmission medium 4 may optionally comprise amplifying circuit arrangements 9 which increase the power level of received signals before retransmission. Such amplifying circuit arrangements preferably operate bidirectionally, amplifying signals applied at a first connection port and delivering them to a second output port, while simultaneously amplifying signals applied at the second port and delivering them to the first port. A repeater with directly connected donor and service feeds with no intermediate amplifying circuits is known as a passive repeater; a repeater comprising amplifying circuit arrangements is known as an active repeater.

The operation of a passive antenna such as a lens antenna is reciprocal, that is to say its characteristics such as its gain and beamwidth are identical whether it is used at a given frequency for the transmission or the reception of radio signals, so even where not specifically mentioned herein it can be assumed that the characteristics of each antenna are identical for transmission or reception.

The intensity of radio signals arriving at the repeater from a donor base station, and also from a user device located in a service beam, are characterized by their power density measured in watts per square meter. It therefore follows that the diameter of the spherical lens determines the amount of power intercepted. Increasing the diameter of the lens increases the intercepted power, permitting a longer distance between the donor base station and the repeater or a larger range for the service beam. However, increasing the diameter of the lens also reduces the beamwidth of the donor and service beams. As the donor beam becomes narrower, it becomes increasingly difficult to align the donor feed unit with sufficient accuracy to direct the maximum of the donor beam towards the donor base station. Narrowing of the service beam extends the range of the service area but reduces its angular extent; this may be a desirable effect in some circumstances, but the limited angular extent of the service area may be a disadvantage in other circumstances.

FIGS. 2(a), 2(b) show simplified details of a prior art mechanical arrangement providing support for a substantially spherical dielectric lens 1 and feed units 2, 3. Feed units 2, 3 are slidably attached to arcuate support members 20, 21. The first support member 20 is rotatably attached to the spherical lens 1 by an elongate screw or pin 22, and a flanged bush 24, and the second support member 21 is rotatably attached to the spherical lens by an elongate screw or pin 23 and a flanged base 26. Angular scales 27, 28 and scale markings on arcuate support members 20, 21 assist with the adjustment of the positions of feed units 2, 3 such that donor and service beams are directed towards the donor base station and the intended service area respectively.

### SUMMARY OF THE DISCLOSURE

It has been found in practice that in some circumstances it is advantageous to adapt the shape of beams provided by a repeater, for example to widen the area over which service is provided by one or more service beams, or to facilitate the alignment of a donor beam on a supporting base station. Among other things, the present disclosure provides for this adjustment of beam shape, thereby extending the utility and range of applications of a repeater employing a lens antenna.

The present disclosure relates to a wireless repeater device provided with at least one lens antenna and associated feed units, together with arrangements to enable at least one feed unit to be displaced in a radial direction with respect to the lens, thereby varying the shape of the radiation pattern formed by the said lens and said feed unit. The arrangement disclosed may be applied to a plurality of feed units each supporting a donor beam or a service beam, and may be applied to active or passive repeaters.

This summary is not intended to identify all essential features of the claimed subject matter, nor is it intended for use in determining the scope of the claimed subject matter. It is to be understood that both the foregoing general description and the following detailed description are exemplary and are intended to provide an overview or framework to understand the nature and character of the disclosure.

### BRIEF DESCRIPTION OF THE DRAWINGS

The accompanying drawings are incorporated in and constitute a part of his specification. It is to be understood that the drawings illustrate only some examples of the disclosure and other examples or combinations of various examples that are not specifically illustrated in the figures may still fall within the scope of this disclosure. Examples will now be described with additional detail through the use of the drawings, in which:

FIG. 1 is a diagram showing the principle of operation of a prior art arrangement of a repeater system employing a spherical dielectric lens antenna;

FIG. 2(a) shows an exploded view of a practical embodiment of a prior art passive repeater system employing a spherical dielectric lens antenna;

FIG. 2(b) shows the assembly of a passive repeater system employing a spherical dielectric lens antenna;

FIG. 3 shows an example of an arrangement according to the present disclosure by which the angular widths of donor and/or service beams may be varied;

FIG. 4 shows radiation patterns of a repeater provided with a lens antenna exemplifying measured changes in beamwidth and beam shape caused by radial displacement of the feed unit;

FIG. 5 shows a standard system of spherical geometrical coordinates;

FIG. 6(a) shows an exploded view of a mounting arrangement providing both radial and circumferential movement for a feed unit; and

FIG. 6(b) shows a lens antenna provided with two mounting arrangements supporting feed units supporting donor and service beams.

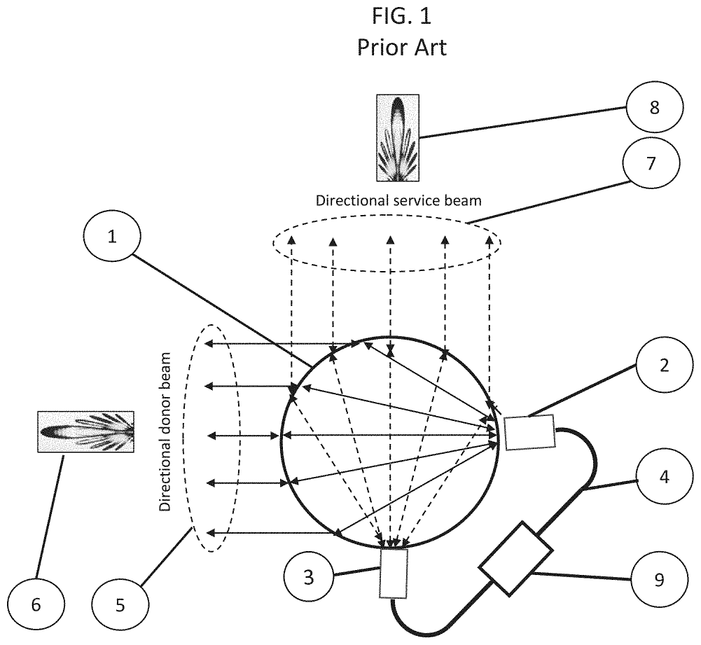

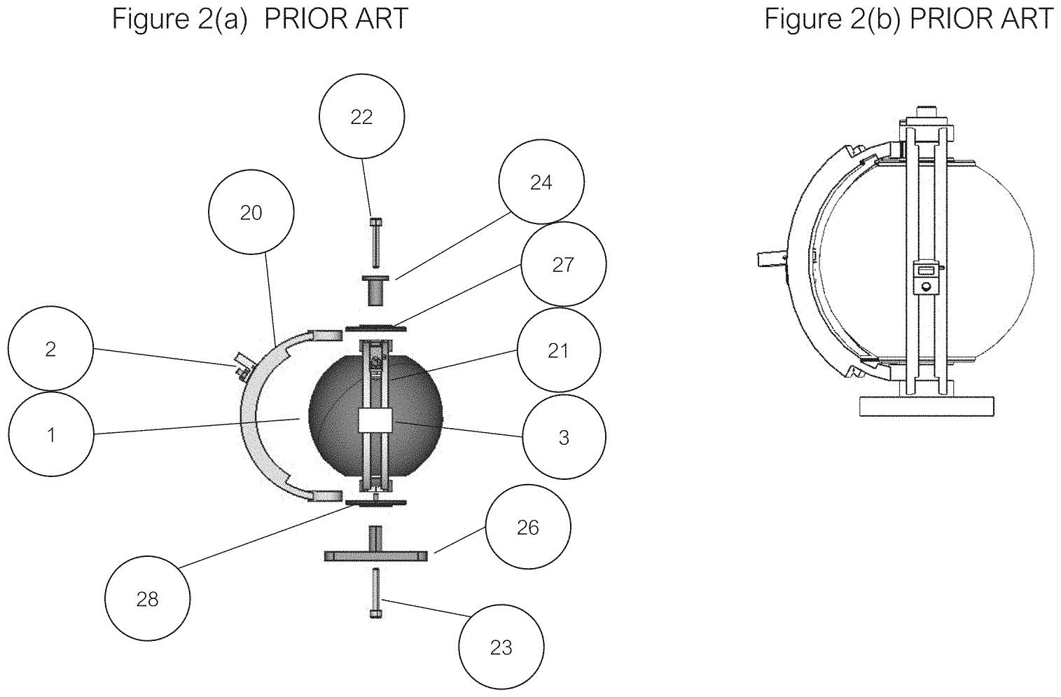

### DETAILED DESCRIPTION OF PREFERRED EMBODIMENTS

In describing the illustrative, non-limiting embodiments illustrated in the drawings, specific terminology will be resorted to for the sake of clarity. However, the disclosure is not intended to be limited to the specific terms so selected, and it is to be understood that each specific term includes all technical equivalents that operate in similar manner to accomplish a similar purpose. Several embodiments are described for illustrative purposes, it being understood that the description and claims are not limited to the illustrated embodiments and other embodiments not specifically shown in the drawings may also be within the scope of this disclosure.

The present disclosure provides for an arrangement by which, in addition to adjustment of their mutual directions in both azimuth and elevation planes, beamwidths of donor and service beams may be independently varied.

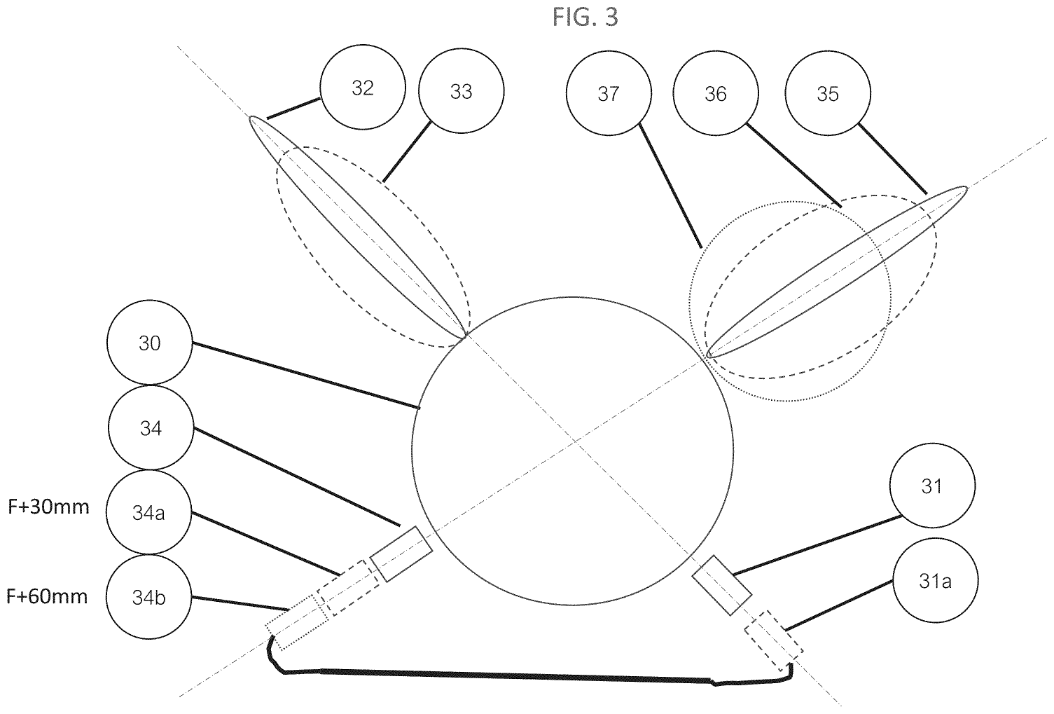

FIG. 3 shows an arrangement according to the present disclosure by which a substantially spherical dielectric lens 30 is provided with first and second feed units 31, 34.

When located at the focal point of the lens, the first feed unit 31 provides a highly directional beam 32. However, if displaced radially (toward or away, with respect to the initial position) from the center of the lens 30, for example to position 31a, the beam supported by the feed unit 31 becomes broader, for example as shown as beam 33. In a similar manner, the second feed unit 34 has a supporting beam 35. The second feed unit 34 may be displaced radially inwardly or outwardly to positions 34a, 34b, providing beams 36, 37 which are progressively wider than beam 35. It will be understood that the radial movement of the feed units may be provided by a sliding arrangement capable of providing any intermediate radial feed position and thereby providing corresponding continuous adjustment of beamwidth. As shown, a cable can connect the two feed units 31, 34. In addition, an amplifier can optionally be connected to the cable to boost the signal.

The arrangement described may be applied to a single feed unit or multiple feed units sharing a common spherical lens. In one example embodiment, some feed units may be arranged to lie at the focus of the lens. Others feed units may be provided with radially adjustable mounting arrangements according to the present disclosure, permitting adjustment of the gain and beamwidth of the service or user beams they support.

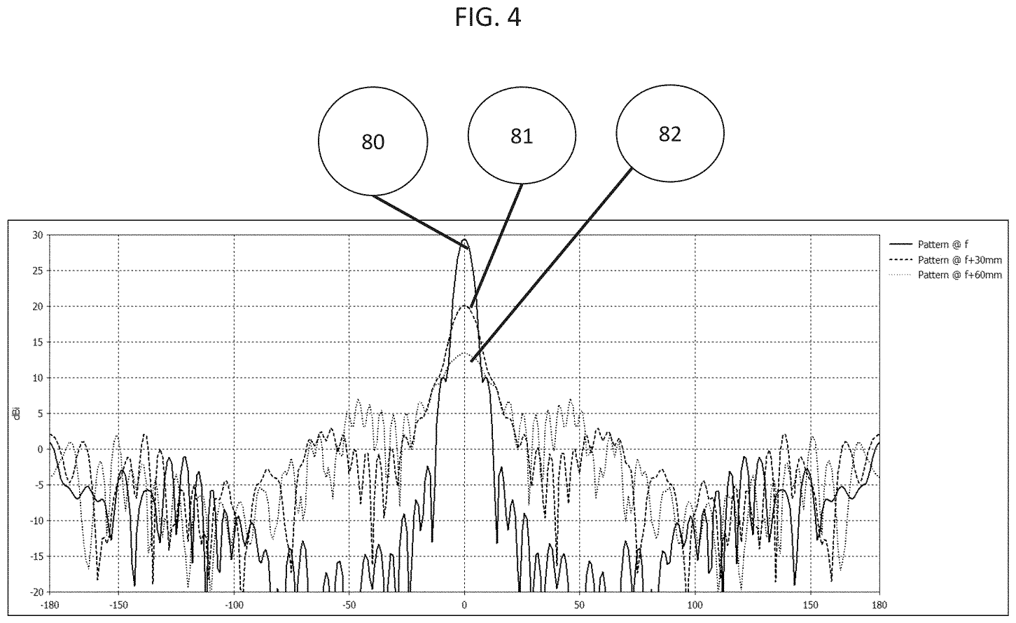

FIG. 4 shows measured radiation patterns for a lens antenna having a diameter of 91 mm, provided with a feed unit in the form of a pyramidal horn, measured at a frequency of 39 GHz for three different radial positions of the feed unit. The horizontal axis of the graph is scaled in degrees from the axis of symmetry of the combination of the feed unit and spherical lens. The vertical axis of the graph is scaled in decibels and indicates the relative power radiated in each azimuth direction. When the feed unit is positioned at the focus of the spherical lens, e.g. for feed unit 34 in FIG. 3, the angular width of the beam 80 measured, by way of example, at a level 10 dB below the beam peak (the 10-dB beamwidth) is approximately 12 degrees. When the feed unit is displaced radially by 30 mm from the focus of the spherical lens, e.g. at position 34a, the 10-dB beamwidth for the resulting beam 81, increases to approximately 2.0 degrees and when displaced by 60 mm, e.g. at position 34b, the 10-dB beamwidth for the resulting beam 82 increases to approximately 30 degrees; the gain at beam peak falls correspondingly from 30 dBi (for beam 80) to 20 dBi (for beam 81) and then to 13 dBi (for beam 82), These changes in beamwidth and gain equally affect both transmission and reception of radio signals and will also apply in the same way whether the repeater is a passive repeater with donor and service feed units connected by passive transmission media or an active repeater wherein the interconnection of donor and service feed units comprises electronic amplifying circuits. For any specific practical application the required values of gain and beamwidth of the donor and service beams, together with any requirement for the use of amplifying circuits, are dependent on the distance between the repeater and the donor base station and the distance and angular extent over which user service is to be provided by the repeater.

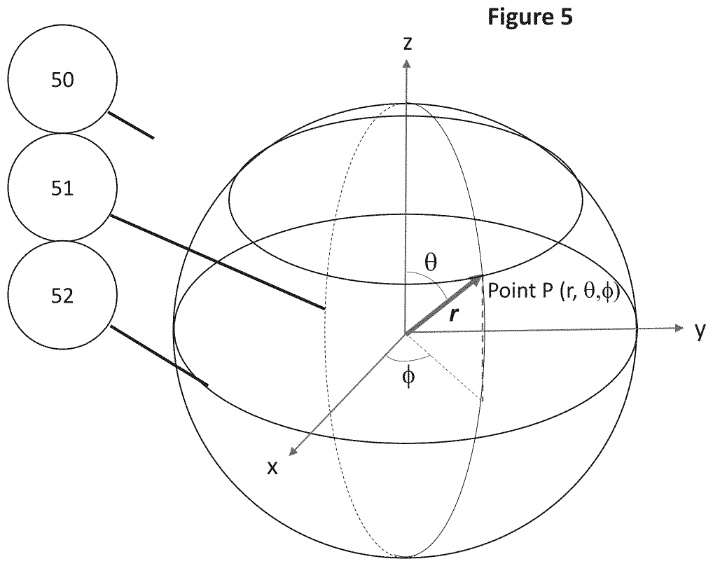

FIG. 5 For the sake of clarity, this figure provides a reference for a conventional set of spherical coordinates 50 that define the coordinates of a point P in terms of radius (r) and the angles theta (θ) and phi (ϕ). The z-axis may also be referred to as the polar axis of the system. Planes containing the polar axis such as 51 are referred to herein as polar planes and the plane 52 defined by θ=90° as the equatorial plane.

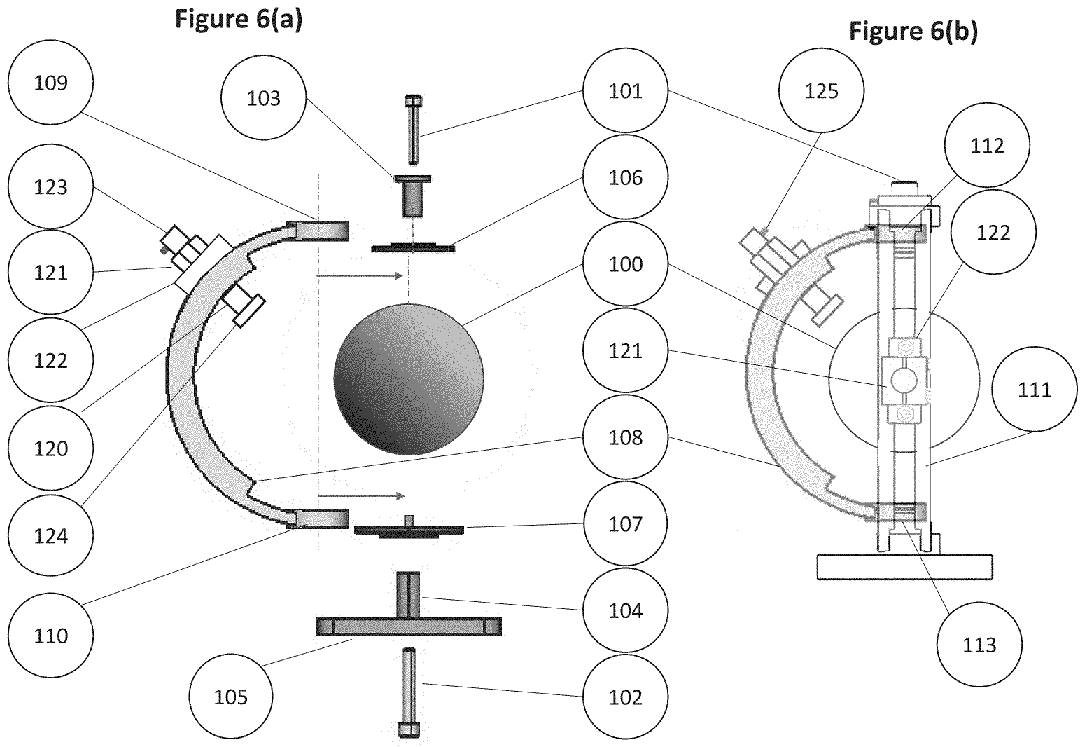

FIGS. 6(a), 6(b) show two views of a lens apparatus having a substantially spherical lens 100, one or more feed units 120, and one or more adjustable positioning system that adjustably positions the feed unit 120 at any location with respect to the lens and/or at any distance from the lens 100. In one embodiment, the lens 100 is spherical and dielectric, though in other embodiments the lens can be non-spherical (e.g., curved, arcuate, or truncated sphere).

It will be understood that the term ‘dielectric lens’ includes any lens substantially constructed from dielectric material, whether having constant permittivity or having an effective permittivity that varies with radial distance from the center of the lens, for example a Luneberg lens. The term ‘dielectric material’ includes both natural dielectric materials, for example polyethylene or Rexolite®, and also artificial dielectric materials, for example those comprising conductive materials whether or not dispersed within a matrix of electrically non-conductive materials.

In the example embodiment shown, the positioning system includes one or more arcuate support members 108, 111, and first and second rotating connections that rotationally couple the support members 108, 111 to the spherical lens 100. The support members 108, 111 are at a fixed distance from the center of the spherical lens 100. The rotating connections can include, for example, first and second respective cylindrical axial members 101, 102 (for example, rods, pins or the like) and first and second respective flanged cylindrical sleeves 103, 104. In the example embodiment shown, the axial member 101, 102 and respective sleeves 103, 104 are positioned at opposite ends of the lens 100, here at the top and bottom, respectively, though other suitable positions can be utilized. The sleeve 104 may be extended radially to provide a mounting base 105 for the assembly. A first substantially planar disc 106 may be attached to the first sleeve 103 such that it remains rotationally fixed relative to the lens 100 and the base 105. In a similar manner, a second substantially planar disc 107 may be rotationally fixed relative to the second sleeve 104.

A first arcuate feed support member 108 is provided with first cylindrical bearing surface 109 at a first end and second cylindrical bearing surface 110 at a second end. Bearing surfaces 109, 110 are supported by sleeves 103, 104 respectively. For example, the lens 100 can have a bore and the bearing surfaces 109, 110 can have a central through-hole that receive the respective sleeves 103, 104; and the sleeves 103, 104 can have a central passage. The axial members 101, 102 can respectively pass through the central passage of the sleeves 103, 104 and the central through-hole of the bearing surfaces 109, 110 and engage the bore of the lens 100. A second arcuate feed support member 111 is provided with cylindrical bearing surfaces 112, 113 supported by sleeve members 103, 104. It will be understood that provided the axial lengths of bearing surfaces is small and their dimensions are suitably arranged, a plurality of arcuate feed support members may be supported by sleeves 103, 104, each support member being capable of substantially independent radial rotation around the axis defined by the said sleeves. Discs 106, 107 may be marked with scales to facilitate adjustment of the relative azimuth bearings of donor and service beams supported by the repeater.

A feed unit 120 is slidably attached to the arcuate support member 108 by first and second adjustable clamps 121, 122 which provide for movement in the radial and circumferential directions respectively relative to the center of spherical lens 100 and include means for fixing the position of feed unit 121 after adjustment is complete.

In one embodiment, the first clamp 121 is fixedly attached to the second clamp 122 (or both clamps 121, 122 can be fixedly attached to a common support or body member). The feed unit 120 is slidably received in the central opening of clamps 121 and 122. The clamps 121, 122 each have an opened or unlocked position, and a closed or locked position. In one example embodiment, the first clamp 121 can be placed in the unlocked position so that the feed unit 120 can slide radially, i.e., inward and/or outward with respect to the central opening of the clamp 121, the arcuate support member 108 and the lens 100, to adjust the distance between the feed unit 120 and the center of the lens 100 to achieve the desired beamwidth and gain such as discussed with respect to FIG. 4. Once the feed unit 120 is at the desired position, the first clamp 121 is closed to lock the feed unit 120 at that desired position. Moving the feed unit in the radial direction allows the lens apparatus to be utilized for different types of coverage. On some occasions it may be found useful to increase the beamwidth of a donor beam while adjusting the alignment of the corresponding donor feed unit by measuring received or transmitted signal levels, and to reduce the beamwidth to the required value after having first discovered the approximate alignment.

In addition, the second clamp 122 is releasably locked to the arcuate support member 108. The second clamp 122 can be placed in the unlocked position so that the feed unit 120 can slide circumferentially, i.e., up and/or down (longitudinally extending from the top to the bottom in the embodiment shown; i.e., in a polar plane or direction) along the arcuate support member 108 with respect to the lens 100, to adjust the relative position of the feed unit 120 to the lens 100.

In addition, the arcuate support member 108 can be rotated with respect to the lens 100 about the first and second rotating connections, i.e. laterally from left to right in the embodiment shown (i.e., in an equatorial plane or direction), and can partially or completely circumnavigate the spherical lens 100. The rotating connections can have a locked position and an unlocked position, and can be placed in the unlocked position to allow the support member 108 to be rotated, and in the locked position to prevent rotation and lock the feed unit 120 and support member 108 at the desired position with respect to the lens 100. As best illustrated in FIG. 5(b), the arcuate support members 108, 111 each have two arms or rails separated by a gap (and connected together by a cross-support or the like) and the respective feed unit 120 is fitted in the gap between the two arms.

Thus, the feed unit 120 can be adjusted to any position on the lens 100 via the first coupling mechanism (e.g., the arcuate support member 108 to move in the phi-direction, i.e., in an equatorial direction or plane (left/right in the embodiments shown)) and second coupling mechanism (e.g., the second clamp 122 to move in the theta-direction, i.e., in a polar direction or plane (up/down)), and at any distance to the lens via the third coupling mechanism (e.g., the first clamp 121 to move in the r-direction, i.e., in a radial direction (in/out)). Each of the coupling mechanisms releasably lock the feed unit to the spherical lens. The clamps 121, 122 may be separate components or may be formed as a single integral piece or component, and can either be locked and unlocked separately or together (simultaneously), and can be operated manually or automatically such as by a motor. In yet another example embodiment, a single positioning device can be provided that simultaneously (manually or automatically) adjusts the radial, longitudinal and/or lateral positions of the feed unit 120.

In one embodiment the feed unit 120 comprises a waveguide, optionally provided with a horn or flange 124 at a first end and a waveguide-to-coaxial transition 123 at a second end having at least one coaxial connector 125, enabling radio signals from a donor feed unit to be connected by a coaxial cable to a corresponding service feed unit. Alternatively, the second end of feed unit 120 may be terminated with a waveguide flange to enable the connection of a length of waveguide between a donor feed unit and a corresponding service feed unit, such waveguide being preferably flexible or readily deformable. Waveguide 120 may have a rectangular cross section and support transmission and reception of plane-polarized signals, or may have a square or circular cross section, supporting the transmission and reception of dual-linear or circularly polarized signals.

In a further embodiment, the feed unit 120 may comprise a printed circuit antenna, for example an array of slot or patch radiating elements.

Mobile radio systems commonly employ dual slant linear polarization, so it is advantageous that feed units supporting donor and service beams, together with interconnecting transmission lines are configured to support dual slant linear polarization for both donor and service beams.

The arrangement herein described provides for improved adaption of a standard configuration of a repeater having lens antenna provided with inter-connected donor and service feed units to the specific requirements of individual practical use cases. In many use cases it may be necessary to optimize the configuration of each feed unit to provide the maximum possible gain available from the lens antenna; in other cases it may be desirable to obtain the maximum possible gain from a donor antenna while serving an area requiring a wider beamwidth from a service beam. The arrangement provided in this disclosure permits both objectives to be served by a standard repeater arrangement, reducing logistical requirements compared with an arrangement requiring physically different repeater antennas for different applications.

It will be understood that the arrangements described above for clamping a feed unit into position may be replaced with arrangements permitting the selection of the position for a feed unit to be controlled by actuators, for example stepper motors, operating under remote control, thereby enabling dynamic control of the coverage of the repeater,

A repeater configured according to the present disclosure may incorporate switching, routing, or passive radio frequency power division arrangements as described in U.S. Patent Application Ser. No. 62/914,063

A repeater configured according to the present disclosure is not limited in operation to any specific frequency band or radio transmission standard, for example it will operate with 5^{th}-generation “5G NR” radio services or any future fixed or mobile radio transmission standard. Applications of the disclosure are not limited to the millimeter-wave frequency band but may for example extend from 10 GHz to 300 GHz. The range of frequencies over which any specific embodiment can operate is primarily dependent on the bandwidth of the feed unit(s) employed and on the bandwidth of any surface matching arrangements, for example grooves or dielectric layers applied to the lens. A lens repeater may be provided with pairs of feed units (one of each supporting a donor beam and the other a service beam) operating in different frequency bands,

It will be apparent to those skilled in the art having the benefit of the teachings presented in the foregoing descriptions and the associated drawings that modifications, combinations, sub-combinations, and variations can be made without departing from the spirit or scope of this disclosure, Likewise, the various examples described may be used individually or in combination with other examples. Those skilled in the art will appreciate various combinations of examples not specifically described or illustrated herein that are still within the scope of this disclosure. In this respect, it is to be understood that the disclosure is not limited to the specific examples set forth and the examples of the disclosure are intended to be illustrative, not limiting.

For example, it is noted that the example embodiments illustrate one way to adjustably move the feed unit in r, theta and phi-directions with respect to a polar coordinate system having its origin at the center of the spherical lens. However, other suitable mechanisms can be provided to move the feed unit, within the spirit and scope of the present disclosure.

As used in this specification and the appended claims, the singular forms “a”, “an” and “the” include plural referents, unless the context clearly dictates otherwise. Similarly, the adjective “another,” when used to introduce an element, is intended to mean one or more elements. The terms “comprising,” “including,” “having” and similar terms are intended to be inclusive such that there may be additional elements other than the listed elements.

It is noted that the drawings may illustrate, and the description and claims may use geometric or relational terms, such as spherical, inward, outward, orthogonal, top, bottom, planar, cylindrical, arcuate, radially, circumferential, axially. These terms are not intended to limit the disclosure and, in general, are used for convenience to facilitate the description based on the examples shown in the figures. In addition, the geometric or relational terms may not be exact. For instance, the lens may not be exactly spherical because of local truncations to facilitate the attachment of mounting arrangements, or for example, roughness of surfaces, tolerances allowed in manufacturing, etc., but may still be considered to be spherical or sufficiently or substantially spherical to be utilized in the present disclosure.

1. A lens apparatus comprising:
a spherical dielectric lens;
a feed unit transmitting and/or receiving signals through said spherical lens; and
an adjustable positioning system that adjustably positions the feed unit at a desired radial distance from said spherical dielectric lens.

2. The lens apparatus of claim 1, said adjustable positioning system further adjustably positioning the feed unit at a desired position in the equatorial and polar planes with respect to said spherical dielectric lens.

3. The lens apparatus of claim 1, wherein said adjustable positioning system comprises a coupling mechanism that releasably locks the feed unit to the spherical lens.

4. The lens apparatus of any of claim 1, wherein said feed unit comprises a donor feed unit and a service feed unit, and further comprising at least one interconnecting guided transmission medium providing a radio frequency transmission path between said donor feed unit and said service feed unit, wherein said adjustable positioning system independently and adjustably positions said donor feed unit at a first desired radial distance from said spherical lens and said service feed unit at a second desired radial distance from said spherical lens.

5. The lens apparatus of claim 4, further comprising at least one additional donor feed unit connected to at least one additional service feed element via coaxial cable to create at least one other repeater to work concurrently with current repeater.

6. The lens apparatus of claim 5, whereby the at least one additional donor teed element, coaxial link and service feed element create at least one additional repeaters on the same spherical dielectric lens operational at the same frequency as the first repeater or a different frequency.

7. The lens apparatus of any of claim 1, further comprising a bi-directional amplifier to boost signal strength and enhance coverage.

8. The lens apparatus of any of claim 1, wherein said feed unit provides a beam having a desired beamwidth, and/or gain based on adjustment of a radial distance between the said feed unit and the said lens.

9. The lens apparatus of claim 8, wherein a beamwidth, and/or gain changes based on a distance of said feed unit to said spherical lens.

10. The lens apparatus of claim 8, wherein said adjustable positioning system moves said feed lens to or away from said feed lens to change the beamwidth and/or gain of said feed lens.

11. The lens apparatus of claim 1, said feed lens comprising an antenna.

12. The lens apparatus of claim 1, said lens apparatus comprising a repeater.

13. The lens apparatus of claim 1, said adjustable positioning system comprising a support member rotationally connected to said spherical lens, said feed unit adjustably mounted to said support member to adjustably position the feed unit at the desired radial distance from the said lens.

14. The lens apparatus of claim 13, wherein said feed member is slidably mounted to said support member.

15. The lens apparatus of claim 1, wherein said adjustable positioning system has a locked position that locks said feed unit at the desired radial distance, and an unlocked position that allows said feed to move radially inward and/or outward with respect to a center of said spherical lens.

16. A lens apparatus comprising:
a spherical dielectric lens;
an arcuate support member;
an antenna feed unit transmitting and/or receiving signals through said spherical lens, said antenna feed unit coupled to said arcuate support member;
a first coupling mechanism rotationally coupling said arcuate support member to said spherical lens to provide movement of said antenna feed unit in a first circumferential direction with respect to said spherical lens, said arcuate support member at a fixed distance to said spherical lens;
a second coupling mechanism slidably mounting said antenna feed unit to said support member in a second circumferential direction substantially orthogonal to the first circumferential direction with respect to said spherical lens; and
a third coupling mechanism slidably mounting said antenna feed unit to said support member in a radial-direction with respect to said spherical lens.

17. The lens apparatus of claim 16, wherein said second coupling mechanism and said first coupling mechanism form a single integral piece.

18. The lens apparatus of claim 16, wherein said first coupling mechanism, second coupling mechanism, and third coupling mechanism each releasably lock said antenna feed unit to said spherical lens.

19. The lens apparatus of claim 16, wherein said antenna feed unit provides a beam having, and the desired radial distance provides a desired beamwidth, and/or gain for the beam.

20. The lens apparatus of claim 19, wherein the beamwidth, and/or gain changes based on a distance of said feed unit to said spherical lens.

21. The lens apparatus of claim 19, wherein said third coupling mechanism moves said feed lens to or away from said feed lens to change the bandwidth and/or gain of said feed lens.

22. The lens apparatus of claim 1, wherein said spherical lens comprises a dielectric lens formed from natural or artificial dielectric structures.
